(19) United States
(12) Patent Application Publication
(10) Pub. No.: US 2024/0272385 A1
(43) Pub. Date: Aug. 15, 2024

(54) UNDERFILL DAM FOR PHOTONIC PACKAGING

(71) Applicant: Cisco Technology, Inc., San Jose, CA (US)

(72) Inventors: Li CHEN, Malboro, NJ (US); Long CHEN, Marlboro, NJ (US); Norbert SCHLEPPLE, Macungie, PA (US); Aparna R. PRASAD, San Jose, CA (US); Vipulkumar K. PATEL, Breinigsville, PA (US)

(21) Appl. No.: 18/167,003

(22) Filed: Feb. 9, 2023

(51) Int. Cl. G02B 6/42

(52) U.S. Cl. CPC G02B 6/4251; G02B 6/4212; G02B 6/4214; G02B 6/4238

(57) ABSTRACT

Photonic packages with underfill dam structures are described. The underfill dam structures address various underfill material location issues by controlling where an underfill material flows and which areas of the photonic package underfill material is excluded from entering.

### TECHNICAL FIELD

Embodiments presented in this disclosure generally relate to photonic packages which connect various optical, electronic, and optoelectronic devices. More specifically, embodiments disclosed herein describe a photonic package with an underfill dam which prevents underfill material from flowing into certain areas of the photonic package.

### BACKGROUND

Photonic packages are increasingly utilized in various capacities including high speed optical networks. The packages often include several different devices and connections to enable various functions on the package itself. As the variety and size of these devices on the photonic packages increase, the various design parameters of the packages are updated to meet the increased demands on the photonic packages. For example, while underfill material provides mechanical stability in photonic packages, the material often interacts with photonic devices in a negative manner, such as decreasing performance of the various photonic devices in the package.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting, other equally effective embodiments are contemplated.

FIGS. 1A and 1B illustrate top views of photonic packages with underfill dams, according to embodiments described herein.

FIGS. 2A-2D illustrate side views of photonic packages with underfill dams, according to embodiments described herein.

FIGS. 3A and 3B illustrate various views of a photonic package with an edge underfill dam, according to embodiments described herein.

FIGS. 4A-4C illustrate various views of a photonic package with an open cavity underfill dam, according to embodiments described herein.

FIGS. 5A-5C illustrate various views of a photonic package with closed cavity underfill dam, according to embodiments described herein.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One example embodiment includes a photonic package. The photonic package includes a substrate for the photonic package. The substrate may include a first surface, where the first surface may include a first region and a second region. The photonic package also includes a plurality of connection components formed on the first surface of the substrate in the first region, a first photonic device attached to the substrate via the plurality of connection components forming an underfill space between a first side of the first photonic device and the first region of the substrate, and an underfill dam. The underfill dam is formed along a first edge side of the first photonic device between the first region and the second region and formed between the first side of the first photonic device and the first surface of the substrate. The photonic package also includes an underfill material filling the underfill space between the first side of the first photonic device and the first surface of the substrate, where the underfill dam separates the second region from the underfill material in the underfill space.

One example embodiment includes a photonic package. The photonic package includes a first photonic device with a first surface, where the first surface may include a first region and a second region, and a plurality of connection components formed on the first surface of the first photonic device in the first region. The photonic package also includes a second photonic device attached to the first photonic device via the plurality of connection components forming an underfill space between a first side of the second photonic device and the first region of the first photonic device and an underfill dam. The underfill dam is formed along a border between the first region and the second region and between the first side of the second photonic device and the first surface of the first photonic device. The underfill dam may include: a first section attached to the first photonic device and with a first width along the first surface of the first photonic device and a second section attached to the second photonic device with a second width long the first surface of the second photonic device. The first width is greater than the second width. The photonic package also includes a bonding section joining the first section and the second section to form the underfill dam and an underfill material filling the underfill space between the first side of the second photonic device and the first surface of the first photonic device, where the underfill dam separates the second region from the underfill material in the underfill space.

One example embodiment includes a photonic package. The photonic package includes a base structure with a first surface, where the first surface may include a first region and a second region, where the second region is located within the first region. The photonic package also includes a plurality of connection components formed on the first surface of the base structure in the first region, a first photonic device attached to the base structure via the plurality of connection components forming an underfill space between a first side of the first photonic device and the first region of the base structure. The photonic package also includes an underfill dam formed along a closed loop border between the first region and the second region and between the first side of the first photonic device and the first surface of the base structure. The package also includes a closed cavity formed between the second region and the first side of the first photonic device; and an underfill material filling the underfill space between the first side of the first photonic device and the first surface of the base structure, where the underfill dam separates the second region from the underfill material in the underfill space.

### EXAMPLE EMBODIMENTS

Many photonic packages provide a variety of functions including optical coupling between various devices in the packages. Optical edge coupling to photonic integrated circuits (PICs) requires sufficient exposed facet area for a fiber (or fiber array) to attach to the package, as well as providing a vertical clearance to the underlying substrate. In some other cases, such optical edge coupling includes free-space optical path and requires exposed facet area to be smooth and uniform. IC underfill material often protrudes from underneath an associated PIC and creates a fillet along the optical facet, which limits clearance for a fiber attachment. This problem becomes more pronounced as PIC thickness is reduced such as in through silicon via (TSV)-enabled applications, where PIC thickness is approximately 100 microns.

Additionally, some photonic elements on the PIC or photonic package are not compatible with the underfill or their performance is degraded by the underfill. These elements may require a local air ambient environment (instead of underfill) due to optical, electrical, mechanical and thermal requirements. These elements may include suspended thermo-optic phase shifter (TOPS), suspended waveguide-fiber coupler, waveguides with air cladding, grating couplers, angled mirrors to direct in-plane light out of plane, etc. For example, a suspended TOPS has part of the silicon substrate etched away to increase the electric power efficiency of driving the TOPS. As underfill fills the air cavity, it increases the thermal dissipation into the silicon substrate and reduces a power efficiency of the TOPS by a factor of 3-4.

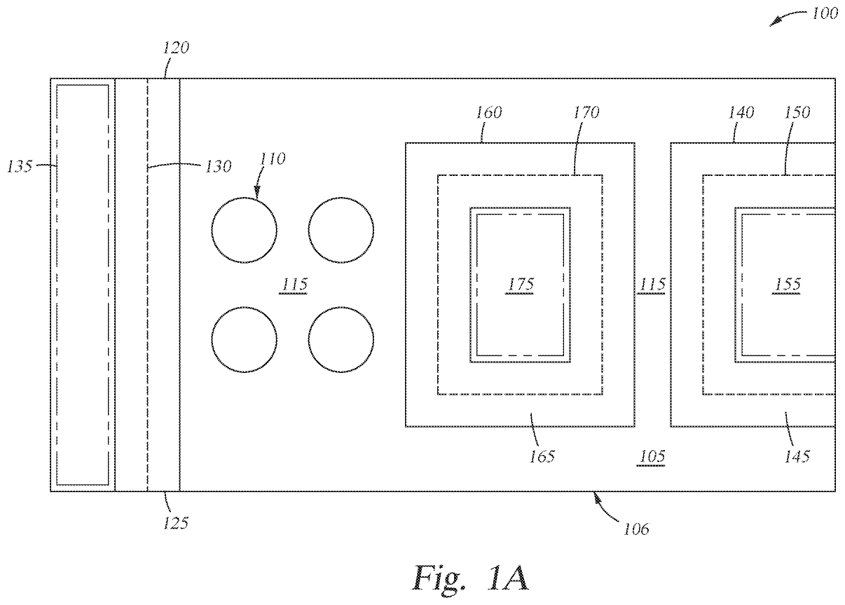

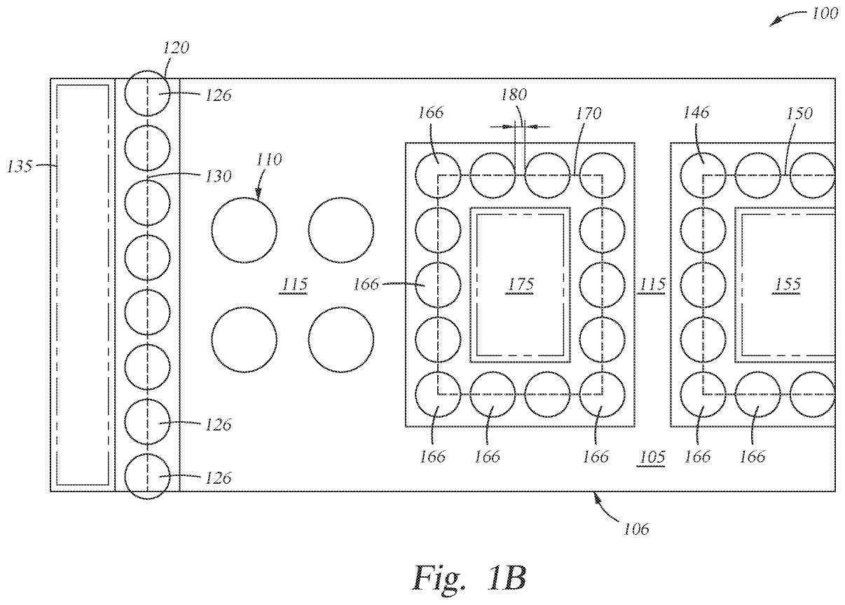

The photonic packages described herein address the underfill material location issues by providing underfill dam structures which control where an underfill material flows and which areas of the photonic package underfill material is excluded from entering as described in relation to FIGS. 1A-5C.

FIGS. 1A and 1B illustrate top views of photonic packages with underfill dams, according to embodiments described herein. For ease of illustration, the top views of the photonic package 100, shown in FIGS. 1A and 1B, are illustrated without a top photonic device positioned above the various components described herein. The photonic package 100 includes a base structure 105. In some examples, the base structure is a substrate for the photonic package 100. The base structure 105 may also be an electronic integrated circuit (EIC), a silicon interposer, a photonic integrated circuit (PIC), an organic substrate, or other similar device/component in a photonic package.

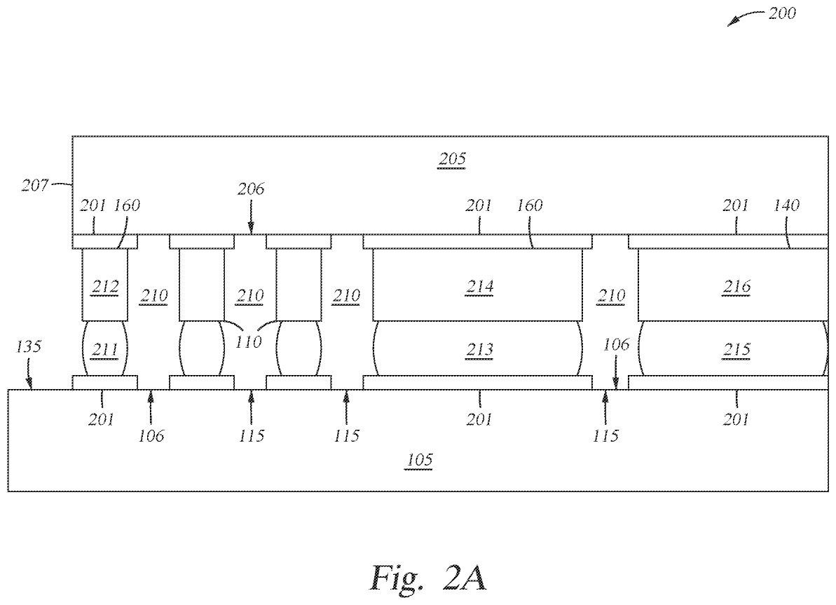

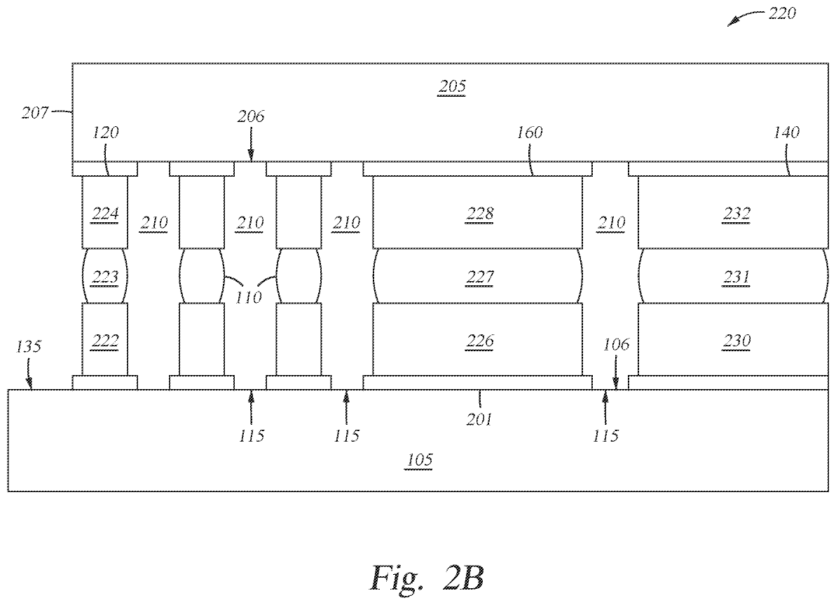

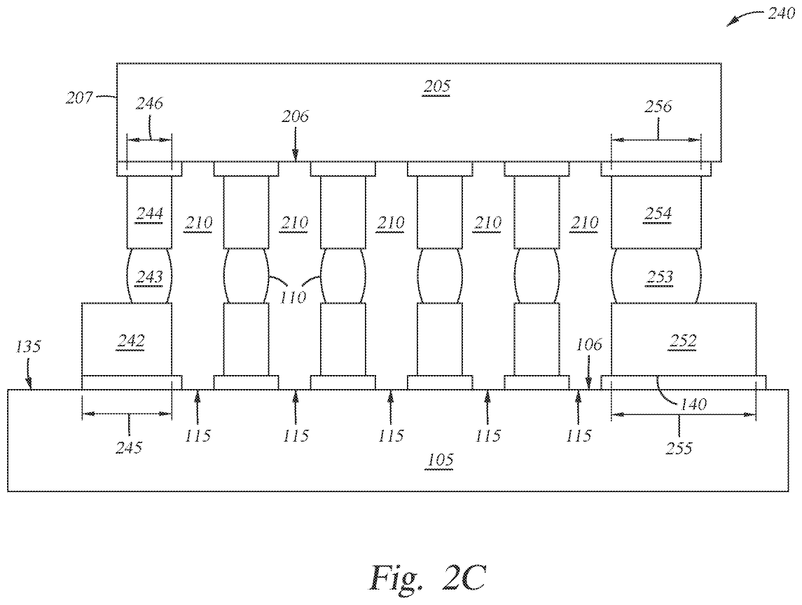

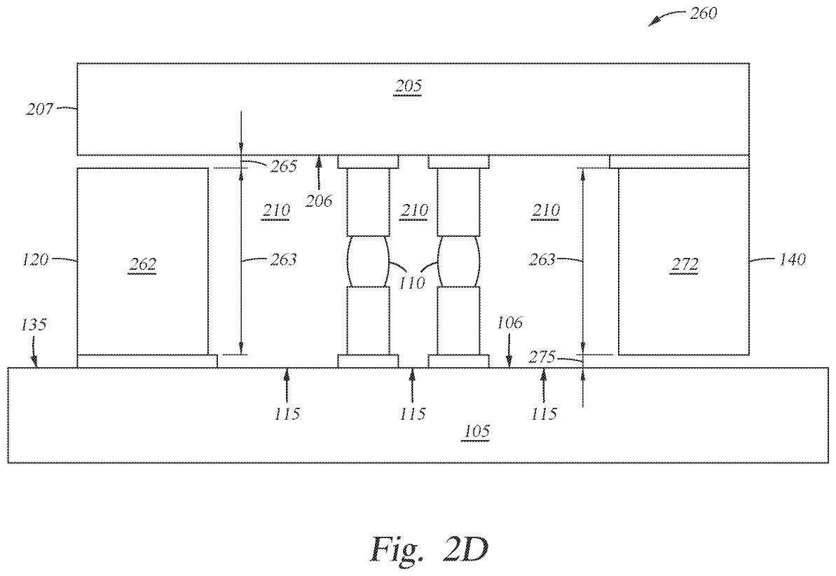

The photonic package 100 also includes connection components 110. In some examples, the connection components 110 are formed on the base structure 105 (e.g., on or extending from a surface 106 of the base structure 105). The connection components 110 provide mechanical and electrical connection points to connect additional photonic components to the photonic package, including to the base structure 105. Additional photonic components are shown in relation to FIGS. 2A-5C.

The photonic package 100 includes underfill dams, such as edge underfill dam 120, open cavity underfill dam 140, and closed cavity underfill dam 160. The edge underfill dam 120 provides an underfill dam along a first edge side of an attached photonic device such as shown in more detail in relation to FIGS. 2A-D and 3A-B. For example, the edge underfill dam 120 is formed along a first edge side of the attached photonic device and along a border 130 between a region 115 of the surface 106 and a region 135 of the surface 106. In some examples, the edge underfill dam 120 includes solid structure 125 as shown in FIG. 1A. The solid structure 125 may include a solid copper structure, such as a copper line or combination of copper lines and solder material to form the solid structure 125. The edge underfill dam 120 may also include a plurality of closely formed structures 126 as shown in FIG. 1B. The plurality of closely formed structures 126 may include a collection of connection components similar to the connection components 110. The plurality of closely formed structures 126 may be spaced apart relative to each other to provide a distance 180 between the structures, where underfill material cannot flow through the space between the plurality of closely formed structures 126. For example, material properties of the underfill material may prevent the material from flowing through the space defined by the distance 180.

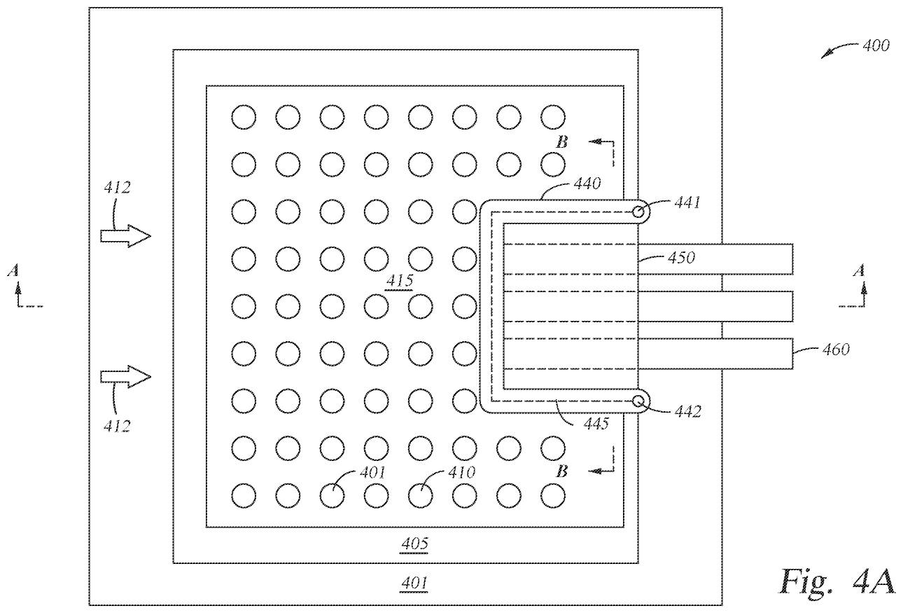

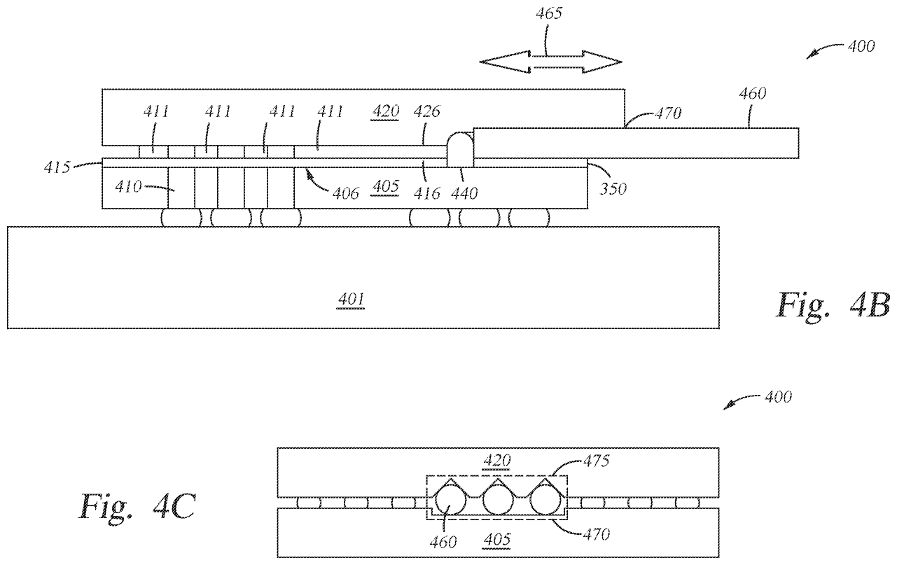

The open cavity underfill dam 140 provides an underfill dam along a border 150 between the region 115 and a region 155 such as shown in more detail in relation to FIGS. 4A-C. In some examples, open cavity underfill dam 140 includes solid structure 145 as shown in FIG. 1A. The solid structure 145 may include a solid copper structure, such as a copper line or combination of copper lines and solder material to form the solid structure 145. The open cavity underfill dam 140 may also include a plurality of closely formed structures 146 as shown in FIG. 1B. The plurality of closely formed structures 146 may include a collection of connection components similar to the connection components 110. The plurality of closely formed structures 146 may be spaced apart relative to each other to provide a distance 180 between the structures, where underfill material cannot flow through the space between the plurality of closely formed structures 146.

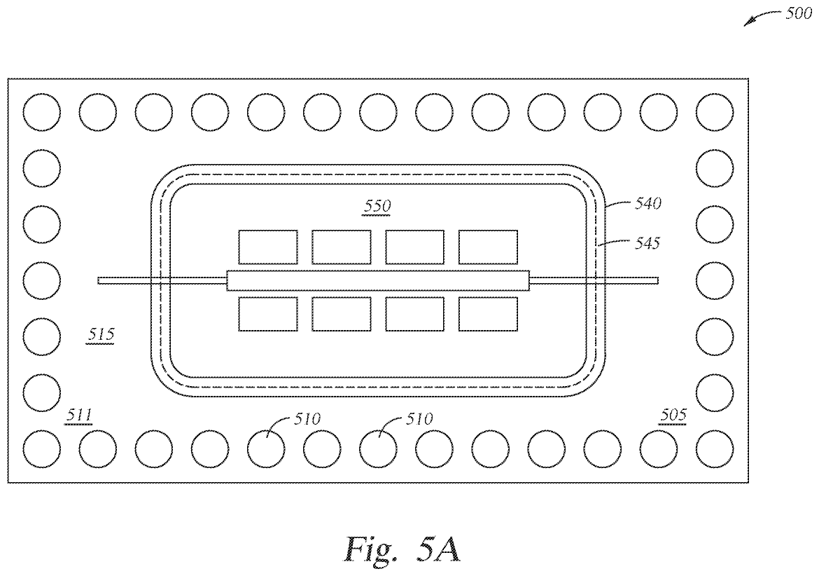

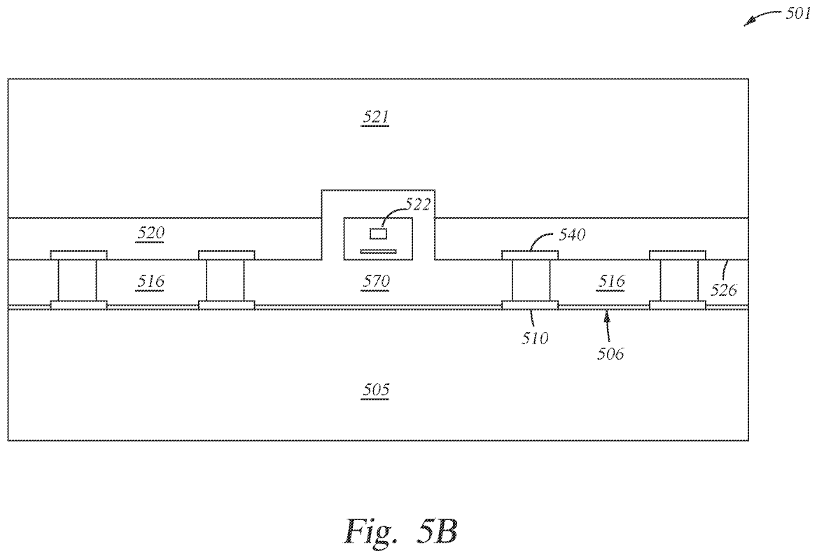

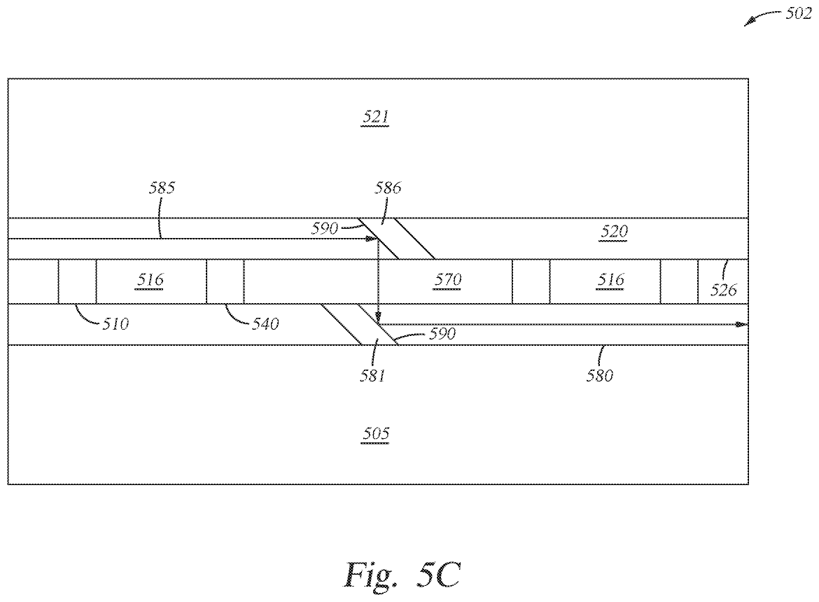

The closed cavity underfill dam 160 provides an underfill dam along a border 170 between the region 115 and a region 175 such as shown in more detail in relation to FIGS. 5A-C. In some examples, closed cavity underfill dam 160 includes solid structure 165 as shown in FIG. 1A. The solid structure 165 may include a solid copper structure, such as a copper line or combination of copper lines and solder material to form the solid structure 165. The closed cavity underfill dam 160 may also include a plurality of closely formed structures 166 as shown in FIG. 1B. The plurality of closely formed structures 166 may include a collection of connection components similar to the connection components 110. The plurality of closely formed structures 166 may be spaced apart relative to each other to provide a distance 180 between the structures, where underfill material cannot flow through the space between the plurality of closely formed structures 166.

FIGS. 2A-2D illustrate side views of photonic packages with underfill dams, according to embodiments described herein. FIGS. 2A-D illustrates a cross-section of an arrangements 200, 220, 240, and 260 respectively, of the photonic package 100 shown in FIGS. 1A-B. The arrangements 200, 220, 240, and 260 each include the base structure 105 and a photonic device 205. In some examples, the base structure 105 is a substrate for a photonic package and the photonic device 205 is a photonic device connected to the base structure via the connection components 110. The base structure 105 and the photonic device 205 include conductive contacts 201 on respective surfaces, surface 106 of base structure 105 and a surface 206 of the photonic device 205. The conductive contacts 201 may include UBM contacts or other contacts/surfaces for forming structures on the surfaces 106 and 206. The arrangements 200, 220, 240, and 260 also includes the edge underfill dam 120, the open cavity underfill dam 140, and the closed cavity underfill dam 160.

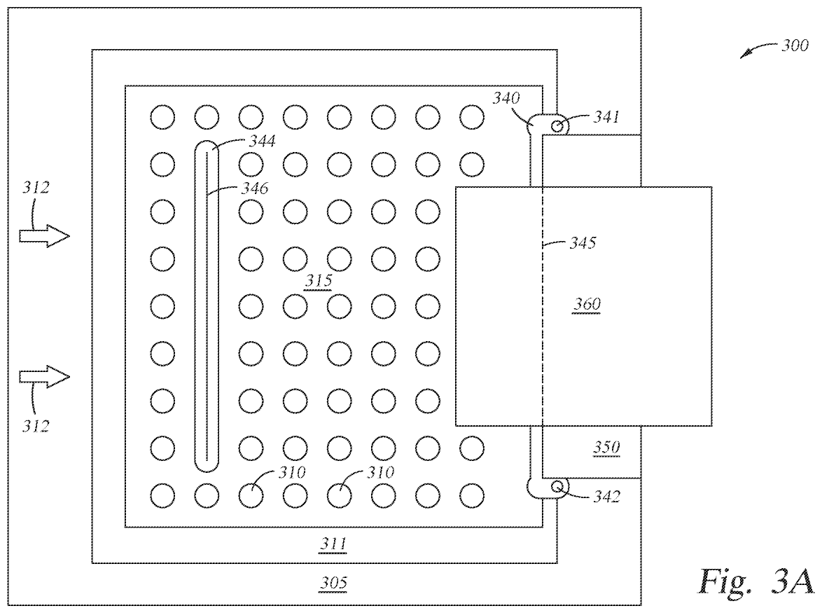

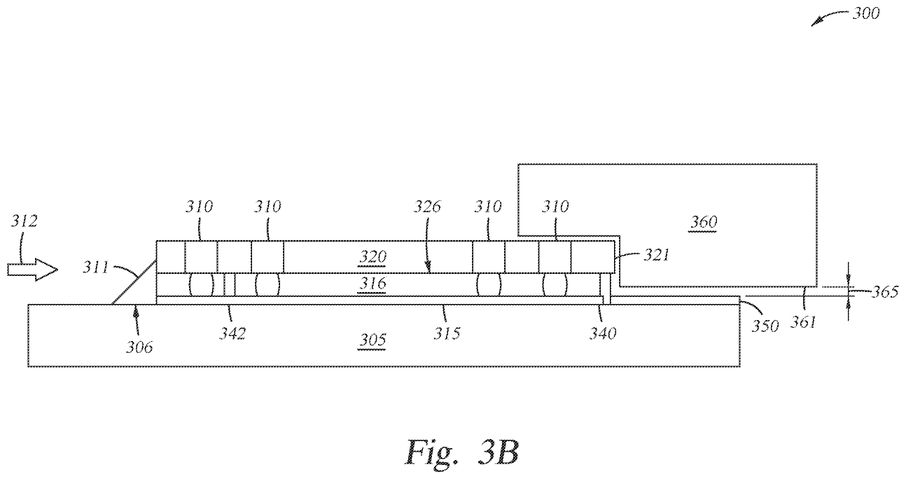

In each of the arrangements 200, 220, 240, and 260 the edge underfill dam 120 is positioned between the base structure 105 and the photonic device 205 adjacent to an edge 207 of the photonic device 205. As shown in FIGS. 1A and 1B, and described in more detail in relation to FIGS. 3A-B, the edge underfill dam 120 prevents underfill material dispensed in underfill space 210 from entering the region 135 of the surface 106 and an area above the region 135.

In each of the arrangements 200, 220, 240, and 260 the open cavity underfill dam 140 is positioned between the base structure 105 and the photonic device 205. As shown in FIGS. 1A and 1B, and described in more detail in relation to FIGS. 4A-C, the open cavity underfill dam 140 prevents underfill material dispensed in underfill space 210 from entering the region 155 of the surface 106 and an area above the region 155.

In each of the arrangements 200 and 220 the closed cavity underfill dam 160 is positioned between the base structure 105 and the photonic device 205. As shown in FIGS. 1A and 1B, and described in more detail in relation to FIGS. 5A-C, closed cavity underfill dam 160 prevents underfill material dispensed in underfill space 210 from entering the region 175 of the surface 106 and an area above the region 175.

In the arrangement 200 of FIG. 2A, the edge underfill dam 120, the open cavity underfill dam 140, and the closed cavity underfill dam 160 are formed using UBM processes and each structure includes a single bump layer and single pillar layer. For example, the edge underfill dam 120 includes a bump 211 and a pillar 212, the open cavity underfill dam 140 includes a bump 215 and a pillar 216, and the cavity underfill dam 160 includes a bump 213 and a pillar 214. In some examples, the bumps 211, 213, and 215 are a solder material and the pillars 212, 214, and 216 are copper pillars formed on surface 206 of the photonic device 205. The bumps 211, 213, and 215 attach the pillars 212, 214, and 216 to the surface 106. Alternatively, the pillars 212, 214, and 216 may be formed on the surface 106 of the base structure 105 with bumps 211, 213, and 215 attach the pillars to the surface 206.

In the arrangement 220 of FIG. 2B, the edge underfill dam 120, the open cavity underfill dam 140, and the closed cavity underfill dam 160 are formed using UBM processes and each structure includes a bump layer and at least two pillar layers. For example, the edge underfill dam 120 includes bonding section, such as a bump 223, between pillars 222 and 224, the open cavity underfill dam 140 includes a bump 231 between pillars 230 and 230, and the cavity underfill dam 160 includes a bump 227 between pillars 226 and 228. In some examples, the bumps 211, 213, and 215 are a solder material, the pillars 222, 226, and 230 are copper pillars formed on surface 106 of the base structure 105, and the pillars 224, 228, and 232 are copper pillars formed on surface 206 of the photonic device 205. The bumps 211, 213, and 215 join the respective pillars together to form the underfill dams.

The arrangement of the bumps and pillars shown in arrangements 200 and 220 may be used in any combination to form the underfill dams and connections points described herein. The arrangements 240 and 260 include variations in the pillars and bumps shown in arrangements 200 and 220. For ease of illustration, the arrangements 240 and 260 include edge underfill dam 120 and open cavity underfill dam 140; however, the structures described may also be implemented in the cavity underfill dam 160 as well as in any combination with the structures described in each of the arrangements in FIGS. 2A-2D.

In the arrangement 240 of FIG. 2C, the edge underfill dam 120 and the open cavity underfill dam 140 are formed using UBM processes and each structure includes a bump layer and at least one pillar layer. For example, the edge underfill dam 120 includes a bump 243 between pillars 242 and 244, and the open cavity underfill dam 140 includes a bump 253 between pillars 252 and 254. In some examples, the bumps 243 and 253 are a solder material, the pillars 242, and 252 are copper pillars formed on surface 106 of the base structure 105, and the pillars 244 and 254 are copper pillars formed on surface 206 of the photonic device 205. The bumps 211, 213, and 215 join the respective pillars together to form the underfill dams. In the arrangement 240, each of the pillars has a respective with width along the adjacent surface (e.g., the surface 106 or 206). For example, the pillar 242 has a cross-sectional width 245 along the surface 106 and the pillar 244 has a cross-sectional width 246 along the surface 206. The pillar 252 has a cross-sectional width 255 along the surface 106 and the pillar 254 has a cross-sectional width 256 along the surface 206.

In some examples, the cross-sectional widths 245 and 255 are greater than the cross-sectional widths 246 and 256. The cross-sectional widths 245 and 255 provide additional prevention of underfill material in the underfill space 210 from entering the regions 135 and 155. For example, the extension of the pillars 242 and 252 prevent underfill material from wrapping around an end of the respective underfill dams and entering the respective regions. The bump and pillars shown in FIG. 2C include two pillar layers; however, the arrangement 240 may also be formed with a single pillar layer (e.g., with just pillars 242 and 252 and solder bumps 243 and 253).

In the arrangement 260 of FIG. 2D, the edge underfill dam 120 and the open cavity underfill dam 140 includes at least one pillar layer. For example, the edge underfill dam 120 includes a pillar 262 attached to the surface 106, and the open cavity underfill dam 140 includes a pillar 272 attached to the surface 206 of the photonic device 205. The pillars 262 and 272 each include a cross-section height 263 such that the pillars positioned in between the base structure 105 and the photonic device 205 form the air gaps 265 and 275. For example, the air gap 265 is formed between a top surface of the pillar 262 and the surface 206. The air gap 275 is formed between a bottom surface of the pillar 272 and the base structure 105. In some examples, the underfill material cannot flow through the air gaps 265 and 275. For example, material properties of the underfill material may prevent the material from flowing through the space defined by the distance 180, discussed in relation to FIG. 2D, which prevents underfill material flow through the air gaps. In some examples, the cavity underfill dam 160 may include one or more of or a combination of the pillars 262 and 272 to form the cavity underfill dam 160.

The photonic package 100 in FIG. 1A and the arrangements 200, 220, 240, and 260 show a combination of underfill dams on a photonic device. In some examples, a device may include multiple dams of a same type (e.g., two edge underfill dams, etc.) and varying combinations of underfill dams (e.g., edge underfill dam, open cavity underfill dam, etc.). Each of the unique aspects of the various types of the underfill dams are shown in more detail in relation to FIGS. 3A-6.

FIGS. 3A and 3B illustrate various views of a photonic package with an edge underfill dam, according to embodiments described herein. FIG. 3A is a top view of photonic package 300 and FIG. 3B is a cross-sectional side view of the photonic package 300. The photonic package 300 includes a base structure 305 and a photonic device 320. For ease of illustration, the top views of the photonic package 300 shown in FIG. 3A is illustrated without the photonic device 320 and the cross-sectional side view in FIG. 3B includes the photonic device 320. In some examples, the base structure is a substrate for the photonic package 300. The base structure 305 may also include a photonic device, such as an EIC, a silicon interposer, a PIC or other similar device/component in the photonic package 300.

The photonic device 320 is attached to the base structure 305 via connection components 310 (e.g., TSV with a solder bump termination), forming an underfill space 316 between side 326 of the photonic device 320 and region 315 on the surface 306. In some examples, the region 315 is an area of the surface 306 associated with the attachment of the photonic device 320 and the base structure 305. One or more of the connection components 310 may be present in the region 315. The connection components may also include an inverse of the structures of the connection components 310 shown in FIG. 3B (such as an inverse of the structure 110 shown in FIG. 2A).

During fabrication, underfill material 311 is dispensed along direction 312 to fill the underfill space 316 and additional locations in the photonic package 300 with the underfill material 311. In some examples, underfill material 311 may cause mechanical complications and optical interference in the photonic package 300. For example, a region 350 of the surface 306 may be an underfill free area to prevent optical or mechanical problems in the photonic package 300. For example, the region 350 is an open connection region, where the edge underfill dam 340 separates the open connection region from the underfill material 311 in the underfill space 316

To prevent underfill material 311 from entering the region 350, the photonic package 300 includes an edge underfill dam 340 formed along an edge side 321 of the photonic device 320. In some examples, the edge underfill dam 340 is formed along the edge side 321 and along a border 345 between a region 315 of the surface 306 and a region 350 of the surface 306. The region 350 is an area of the surface 306 where underfill material is not desired to prevent signal interference in a connection component. For example, the photonic package 300 includes a connection component 360 attached to a connection facet, such as the edge side 321. The connection component 360 may include a fiber array unit (FAU) or other similar optical connection component. In some examples, the connection component 360 is edge coupled to the photonic device 320 via the edge side 321. In some examples, optical edge coupling to PICs such as the photonic device 320, has an associated exposed facet area on the edge side 321 for optical fibers or FAUs to attach to the device.

In some examples, the connection component 360 includes a vertical clearance 365 between a bottom side 361 of connection component 360 and top side of a substrate such as surface 306 of the base structure 305. The vertical clearance 365 reduces optical interference from the base structure 305 and any underfill associated with the base structure. The vertical clearance 365 may include a measurement of approximately 350 microns to avoid optical interference from the substrate. A small relative height or thickness of the photonic device 320 (e.g., 100-200 microns or less) may cause the vertical clearance 365 to be smaller than the designed measurement when the connection component 360 is attached to the photonic device 320. For example, without the edge underfill dam 340, underfill material 311 may enter or protrude into the region 350 while being dispensed. Underfill material in the region 350 reduces the vertical clearance 365 and may contribute to signal interference in the connection component 360 and cause mechanical connection problems when the connection component 360 is attached to the photonic device 320.

In some examples, edge underfill dam 340 includes any of the structures or combination of the structures described in relation to FIGS. 1A-2D. For example, the edge underfill dam 340 may include a section of the underfill dam with a width similar to the cross-sectional width 245 of the pillar 242 to prevent underfill material 311 from entering the region 350 around ends of the underfill dam, such as ends 341 and 342 of the edge underfill dam 340. Additionally, in some examples, an edge underfill dam 340 formed along the edge of the device may cause balance or tip complications in the photonic package 300. To provide tip/tilt compensation in the package, the photonic package 300 also includes compensation dam 344 located in the region 315 to provide a parallel relationship between the surface 306 and the side 326. For example, the compensation dam 344 is formed along an offset line 346 in the region 315. While referred to as a dam, the compensation dam 344 does not prevent any underfill material from flowing into a region or space of the photonic package 300. In some examples, an underfill dam formed near an edge of a photonic device, such as the photonic device 320, may further prevent underfill material from entering a larger region with more connection components as described in relation to FIGS. 4A-C.

FIGS. 4A and 4B illustrate various views of a photonic package with an open cavity underfill dam, according to embodiments described herein. FIG. 4A is a top view of photonic package 400, FIG. 4B is a cross-sectional side view of the photonic package 400 along axis A-A in FIG. 4A, and FIG. 4B is a cross-sectional side view of the photonic package 400 along axis B-B in FIG. 4A. The photonic package 400 includes a substrate 401, a base structure 405, and a photonic device 420. For ease of illustration, the top view of the photonic package 400 shown in FIG. 4A is illustrated without the photonic device 420 and the cross-sectional side views in FIG. 4B and includes the photonic device 420. In some examples, the base structure 405 is a photonic device, such as an EIC, a silicon interposer, a PIC or other similar device/component in the photonic package 400.

The photonic device 420 is attached to the base structure 405 via connection components 410, forming an underfill space 416 (as shown in FIG. 4B) between side 426 of the photonic device 420 and region 415 on the surface 406. In some examples, the region 415 is an area of the surface 406 associated with the attachment of the photonic device 420 and the base structure 405. One or more of the connection components 410 may be present in the region 415. During fabrication, underfill material 411 is dispensed along direction 412 to fill the underfill space 416 and additional locations in the photonic package 400 with the underfill material 411. In some examples, underfill material 411 may cause mechanical complications and optical interference in the photonic package 400. For example, a region 450 of the surface 406 may be an underfill free area to prevent optical or mechanical problems in the photonic package 400. For example, the region 450 is an open cavity connection region, where the open cavity underfill dam 440 separates the open cavity connection region from the underfill material 411 in the underfill space 416

To prevent underfill material 411 from entering the region 450, the photonic package 400 includes an open cavity underfill dam 440 formed along a border 445 between the region 415 of the surface 406 and a region 450 of the surface 406. The border 445 may include non-linear segments between ends 441 and 442. The region 450 is an area of the surface 406 where underfill material is not desired to prevent signal interference in a connection component. For example, the photonic package 400 includes a connection component 460 including an optical transmission medium coupled to a facet within an open cavity 470. The connection components 460 may include individual fibers, waveguides, or other similar optical connection component(s). In some examples, the connection component 460 is coupled/attached to the photonic device 420 and the base structure using optical connection features 475. The optical connection features 475 may include fiber alignment features (e.g., v-grooves, etc.) formed into the photonic device 420 and the base structure 405. In some examples, fiber/waveguide coupling to PICs such as the photonic device 420, has an associated insertion depth 465 for optical fibers to attach to the device with mechanical stability.

In an example without the open cavity underfill dam 440, underfill material 411 may enter or protrude into the region 450 and the open cavity 470 while being dispensed. Underfill material in the region 450 may prevent mechanical attachment and optical coupling of the connection component 460 to the photonic device 420. The open cavity 470 may be formed between the surface 406 and a recess surface formed in the side 426 of the photonic device. As shown in FIG. 4C, the open cavity 470 provides an open facet side between the photonic device 420 and the base structure 405.

In some examples, open cavity underfill dam 440 includes any of the structures or combination of the structures described in relation to FIGS. 1A-2D. For example, the open cavity underfill dam 440 may include a section of the underfill dam with a width similar to the cross-sectional width 245 of the pillar 242 to prevent underfill material 411 from entering the region 450 around ends of the underfill dam, such as ends 441 and 442 of the open cavity underfill dam 440. While the dams described in FIGS. 3A-4C are positioned near edges or sides of the components of the photonic packages. An underfill dam may also be positioned to prevent flow of underfill material in an internal section of the photonic package as described in relation to FIGS. 5A-C.

FIGS. 5A-5C illustrate various views of a photonic package with closed cavity underfill dam, according to embodiments described herein. FIG. 5A is a top view of photonic package 500, FIGS. 5B-5C are a cross-sectional side views of the photonic package 500 in various arrangements. The photonic package 500 includes a base structure 405 and a photonic device 520. For ease of illustration, the top view of the photonic package 500 shown in FIG. 5A is illustrated without the photonic device 520 and the cross-sectional side views in FIGS. 5B and 5C includes the photonic device 520 in various arrangements. For example, arrangement 501 in FIG. 5B includes a photonic device 520 with a substrate 521 and at least one optical device 522 suspended within a closed cavity 570. In some examples, such as arrangement 502 in FIG. 5C, the base structure 505 is a photonic device, with a waveguide 580. The photonic device 520 includes a waveguide 585 and a coupling mirror 586, wherein the waveguide 580 is optically coupled to the waveguide 585 via the coupling mirror 581 and the coupling mirror 586. For example, an optical signal 590 between the coupling mirror 581 and the coupling mirror 586 reflects through an air cavity in the closed cavity 570.

In some examples, the photonic device 520 is attached to the base structure 505 via connection components 510, forming an underfill space 516 between side 526 of the photonic device 520 and region 515 on the surface 506. In some examples, the region 515 is an area of the surface 506 associated with the attachment of the photonic device 520 and the base structure 505. One or more of the connection components 510 may be present in the region 515. During fabrication, underfill material 511 is dispensed to fill the underfill space 516 and additional locations in the photonic package 500 with the underfill material 511. In some examples, underfill material 511 may cause mechanical complications and thermal and optical interference in the photonic package 500. For example, a region 550 of the surface 506 may be an underfill free area to prevent optical or thermal problems in the photonic package 400. For example, the region 550 is a closed cavity region, where the cavity underfill dam 540 separates the closed cavity region from the underfill material 511 in the underfill space 516.

To prevent underfill material 511 from entering the region 550, the photonic package 500 includes a closed cavity underfill dam 540 formed along a closed loop border 545 between the region 515 of the surface 506 and a region 550 of the surface 506. The region 550 is an area of the surface 506 where underfill material is not desired to prevent signal interference in a connection component.

In some examples, the closed cavity underfill dam 540 includes any of the structures or combination of the structures described in relation to FIGS. 1A-2D. In some examples, the closed cavity underfill dam 540 may be formed from a polymer material deposited on the surface 506 during fabrication.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. A photonic package comprising:
a substrate for the photonic package comprising a first surface, where the first surface comprises a first region and a second region;
a plurality of connection components formed on the first surface of the substrate in the first region;
a first photonic device attached to the substrate via the plurality of connection components forming an underfill space between a first side of the first photonic device and the first region of the substrate;
an underfill dam formed along a first edge side of the first photonic device between the first region and the second region and formed between the first side of the first photonic device and the first surface of the substrate; and
an underfill material filling the underfill space between the first side of the first photonic device and the first surface of the substrate, where the underfill dam separates the second region from the underfill material in the underfill space.

2. The photonic package of claim 1,
wherein the first edge side of the first photonic device comprises a connection facet,
wherein the second region comprises an open connection region, where the underfill dam separates the open connection region from the underfill material in the underfill space, and
wherein the photonic package further comprises:
a fiber array unit (FAU) attached to the connection facet of the first photonic device.

3. The photonic package of claim 1, further comprising:
a compensation dam formed along an offset line within the first region and between the first side of the first photonic device and the first surface of the substrate, wherein the compensation dam provides tilt compensation for the photonic package.

4. The photonic package of claim 1, wherein the underfill dam comprises:
a first section attached to the substrate and comprising a first width along the first surface of the substrate;
a second section attached to the first photonic device comprising a second width along the first surface of the first photonic device; and
a bonding section joining the first section and the second section to form the underfill dam.

5. The photonic package of claim 4, wherein the first width is greater than the second width.

6. The photonic package of claim 4,
wherein the first section comprises a first copper structure attached to the substrate,
wherein the second section comprises a second copper structure attached to the first photonic device, and
wherein the bonding section comprises a solder bump formed between the first copper structure and the second copper structure.

7. The photonic package of claim 1, wherein the underfill dam comprises:
a first section comprising a first side, wherein the first side of the first section is attached the substrate; and
an air gap between a second side of the first section and the first side of the first photonic device, wherein the second side of the first section is opposite the first side of the first section, wherein the air gap comprises a distance between the second side of the first section and the first side of the first photonic device, wherein the distance prevents underfill material flow through the air gap.

8. The photonic package of claim 1,
a first section comprising a first side, wherein the first side of the first section is attached the first photonic device; and
an air gap between a second side of the first section and the first side of the substrate, wherein the second side of the first section is opposite the first side of the first section, wherein the air gap comprises a distance between the second side of the first section and the first side of the substrate, wherein the distance prevents underfill material flow through the air gap.

9. The photonic package of claim 1, wherein the underfill dam comprises a solid structure formed along the first edge side of the first photonic device.

10. The photonic package of claim 1, wherein the underfill dam comprises a plurality of closely formed structures positioned along the first edge side of the first photonic device to prevent the underfill material from flowing between the plurality of closely formed structures.

11. A photonic package comprising:
a first photonic device comprising a first surface, where the first surface comprises a first region and a second region;
a plurality of connection components formed on the first surface of the first photonic device in the first region;
a second photonic device attached to the first photonic device via the plurality of connection components forming an underfill space between a first side of the second photonic device and the first region of the first photonic device;
an underfill dam formed along a border between the first region and the second region and between the first side of the second photonic device and the first surface of the first photonic device, the underfill dam comprising:
a first section attached to the first photonic device and comprising a first width along the first surface of the first photonic device;
a second section attached to the second photonic device comprising a second width along the first surface of the second photonic device, where the first width is greater than the second width; and
a bonding section joining the first section and the second section to form the underfill dam;
the photonic package further comprising: an underfill material filling the underfill space between the first side of the second photonic device and the first surface of the first photonic device, where the underfill dam separates the second region from the underfill material in the underfill space.

12. The photonic package of claim 11,
wherein the photonic package further comprises:
an open cavity formed between the second region and a recess surface formed in the first side of the second photonic device, wherein the open cavity comprises an open facet side between a first edge side of the second photonic device and first edge side of the first photonic device,
wherein the border between the first region and the second region comprises:
at least one non-linear segment between a first point on the open facet side of the open cavity and a second point on the open facet side of the open cavity;
wherein the underfill dam comprises:
a first end at the first point; and
a second end at the second point.

13. The photonic package of claim 12, wherein the first width of the first section prevents the underfill material from flowing into the open cavity.

14. The photonic package of claim 12,
wherein the open facet side of the open cavity comprises a connection facet,
wherein the second region comprises a cavity connection region, where the underfill dam separates the cavity connection region from the underfill material in the underfill space, and
wherein the photonic package further comprises:
at least one optical transmission medium connected to the second photonic device via a connection within the cavity connection region.

15. The photonic package of claim 14,
wherein the second photonic device further comprises at least one optical connection feature formed on the recess surface, and
wherein the at least one optical transmission medium comprises at least one fiber optically connected to the second photonic device via the at least one optical connection feature.

16. A photonic package comprising:
a base structure comprising a first surface, where the first surface comprises a first region and a second region, where the second region is located within the first region;
a plurality of connection components formed on the first surface of the base structure in the first region;
a first photonic device attached to the base structure via the plurality of connection components forming an underfill space between a first side of the first photonic device and the first region of the base structure;
an underfill dam formed along a closed loop border between the first region and the second region and between the first side of the first photonic device and the first surface of the base structure;
a closed cavity formed between the second region and the first side of the first photonic device; and
an underfill material filling the underfill space between the first side of the first photonic device and the first surface of the base structure, where the underfill dam separates the second region from the underfill material in the underfill space.

17. The photonic package of claim 16, wherein the first photonic device further comprises:
at least one optical device suspended within the closed cavity.

18. The photonic package of claim 16, wherein the closed cavity comprises an air cavity, and wherein the base structure comprises a photonic device comprising a first waveguide and a first coupling mirror;
wherein the first photonic device further comprises a second waveguide and second coupling mirror, wherein the first waveguide is optically coupled to the second waveguide via the first coupling mirror and the second coupling mirror, wherein an optical signal between the first coupling mirror and the second coupling mirror reflects through the air cavity, and
wherein the underfill dam comprises a polymer material.

19. The photonic package of claim 16, wherein the underfill dam comprises:
a first section comprising a first side, wherein the first side of the first section is attached the base structure; and
an air gap between a second side of the first section and the first side of the first photonic device, wherein the second side of the first section is opposite the first side of the first section, wherein the air gap comprises a distance between the second side of the first section and the first side of the first photonic device, wherein the distance prevents underfill material flow through the air gap.

20. The photonic package of claim 16,
a first section comprising a first side, wherein the first side of the first section is attached the first photonic device; and
an air gap between a second side of the first section and the first side of the base structure, wherein the second side of the first section is opposite the first side of the first section, wherein the air gap comprises a distance between the second side of the first section and the first side of the base structure, wherein the distance prevents underfill material flow through the air gap.
